(19) United States
(12) Patent Application Publication
(10) Pub. No.: US 2025/0135806 A1
(43) Pub. Date: May 1, 2025

(54) PNEUMATIC TIRE FOR HEAVY LOADS

(71) Applicant: TOYO TIRE CORPORATION, Itami-shi (JP)

(72) Inventor: Kie Takagi, Itami-shi (JP)

(73) Assignee: TOYO TIRE CORPORATION, Itami-shi (JP)

(21) Appl. No.: 18/928,448

(22) Filed: Oct. 28, 2024

(30) Foreign Application Priority Data
Oct. 31, 2023 (JP) 2023-186465

(51) Int. Cl. B60C 9/20

(52) U.S. Cl. CPC B60C 9/20; B60C 2009/2016; B60C 2009/2067; B60C 2200/06

(57) ABSTRACT

A pneumatic tire includes a belt layer composed of three layers of belts and a rubber layer disposed between a carcass ply and a tread. Each belt has a plurality of cords and a topping rubber covering the plurality of cords. The belt layer includes: a first belt disposed on an outer side of the rubber layer in a tire radial direction; a second belt disposed on an outer side of the first belt in the tire radial direction; and a third belt disposed on an outer side of the second belt in the tire radial direction. A modulus of the rubber layer is the same as a modulus of the topping rubber of the first belt. The rubber layer has a thickness of 1.5 mm or more and 2.0 mm or less.

### CROSS REFERENCE TO RELATED APPLICATION

This application claims benefit of priority to Japanese Patent Application 2023-186465, filed Oct. 31, 2023, the entire content of which is incorporated herein by reference.

### BACKGROUND

### Technical Field

The present disclosure relates to a pneumatic tire for heavy loads.

### Background Art

JP 2001-138711 A discloses a pneumatic tire for heavy loads including a carcass layer extending in a substantially toroidal shape and a belt layer disposed radially outside the carcass layer and including four or more belt plies.

### SUMMARY

In the pneumatic tire for heavy loads described in JP 2001-138711 A, since the belt layer is formed of four or more layers of belt plies, the radial binding force by the belt layer becomes excessively strong, and the tread of the tire hardly deforms following the road surface. As a result, non-uniformity of circumferential distribution of the ground contact pressure on the tire ground contact surface of the pneumatic tire increases. However, J P 2001-138711 A does not describe the uniformity of circumferential distribution of the ground contact pressure on the tire ground contact surface.

An object of the present disclosure is to provide a pneumatic tire for heavy loads capable of improving uniformity of circumferential distribution of a ground contact pressure on a tire ground contact surface.

One aspect of the present disclosure provides a pneumatic tire for heavy loads, including: a belt layer composed of three layers of belts; and a rubber layer, the belt layer and the rubber layer being disposed between a carcass ply and a tread, each belt having a plurality of cords and a topping rubber covering the plurality of cords,
in which the belt layer includes:
   a first belt disposed on an outer side of the rubber layer in a tire radial direction;
   a second belt disposed on an outer side of the first belt in the tire radial direction; and
   a third belt disposed on an outer side of the second belt in the tire radial direction,
in which a modulus of the rubber layer is the same as a modulus of the topping rubber of the first belt, and
in which the rubber layer has a thickness of 1.5 mm or more and 2.0 mm or less.

According to this configuration, since the pneumatic tire includes the belt layer composed of three layers of belts, it is possible to suppress an excessive increase in the radial binding force by the belt layer as compared with a case where the belt layer includes four or more layers of belts. As a result, the tread of the tire is easily deformed following the road surface, and the uniformity of circumferential distribution of the ground contact pressure on the tire ground contact surface can be improved.

The rubber layer disposed between the belt layer and the carcass ply functions as a buffer layer that absorbs the deformation of the carcass ply, so that the deformation of the carcass ply can be prevented from being transmitted to the belt layer and the tread.

In addition, since the modulus of the rubber layer is the same as the modulus of the topping rubber of the first belt, the rubber layer and the topping rubber of the first belt exhibit substantially the same behavior when a load is applied to the pneumatic tire. As a result, it is possible to suppress the occurrence of separation between the rubber layer and the first belt.

In addition, since the thickness of the rubber layer is 1.5 mm or more and 2.0 mm or less, sufficient impact resistance of the pneumatic tire can be secured, and the rubber layer can be suppressed from becoming excessively thick.

According to the present disclosure, it is possible to provide the pneumatic tire for heavy loads capable of improving the uniformity of circumferential distribution of the ground contact pressure on the tire ground contact surface.

### BRIEF DESCRIPTION OF DRAWINGS

FIG. 1 is a meridian sectional view of a pneumatic tire according to an embodiment of the present disclosure;

FIG. 2 is an enlarged view of a region R in FIG. 1;

FIG. 3 is a developed view of a rubber layer and a belt layer of the pneumatic tire shown in FIG. 1;

FIG. 4 is a schematic partial cross-sectional view showing the pneumatic tire under load; and

FIG. 5 is an enlarged view similar to FIG. 2 of a pneumatic tire according to a modification of the embodiment of the present disclosure.

### DETAILED DESCRIPTION

Hereinafter, a pneumatic tire for heavy loads according to an embodiment of the present disclosure will be described with reference to the drawings. Note that the following description is merely exemplary in nature and is not intended to limit the present disclosure. In addition, the drawings are schematic, and ratios of dimensions and the like are different from actual ones.

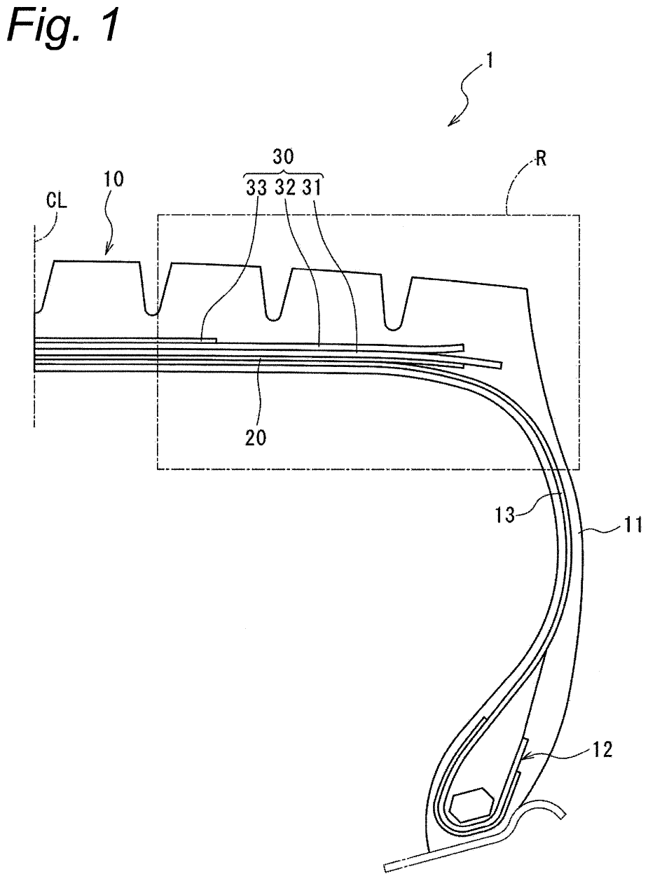

FIG. 1 is a cross-sectional view in a meridian direction of a pneumatic tire 1 for heavy loads (hereinafter, it may be simply referred to as a pneumatic tire 1) according to the present embodiment. In FIG. 1, only one side in a tire axial direction with respect to a tire equator line CL is shown. The pneumatic tire 1 of the present embodiment is a heavy load tire made of rubber. The heavy load tire is a tire described in “Chapter C: for trucks and buses” or “Chapter D: for construction vehicles” of Japan Automobile Tire Manufacturers Association (JATMA) standard.

The pneumatic tire 1 includes a tread 10, a pair of sidewalls 11 extending inward in a tire radial direction from both axial ends of the tread 10, and a pair of beads 12 respectively continuous to radially inner ends of the pair of sidewalls 11. A carcass ply 13 is disposed between the pair of beads 12. A rubber layer 20 and a belt layer 30 composed of three layers of belts 31, 32, and 33 are disposed between the carcass ply 13 and the tread 10.

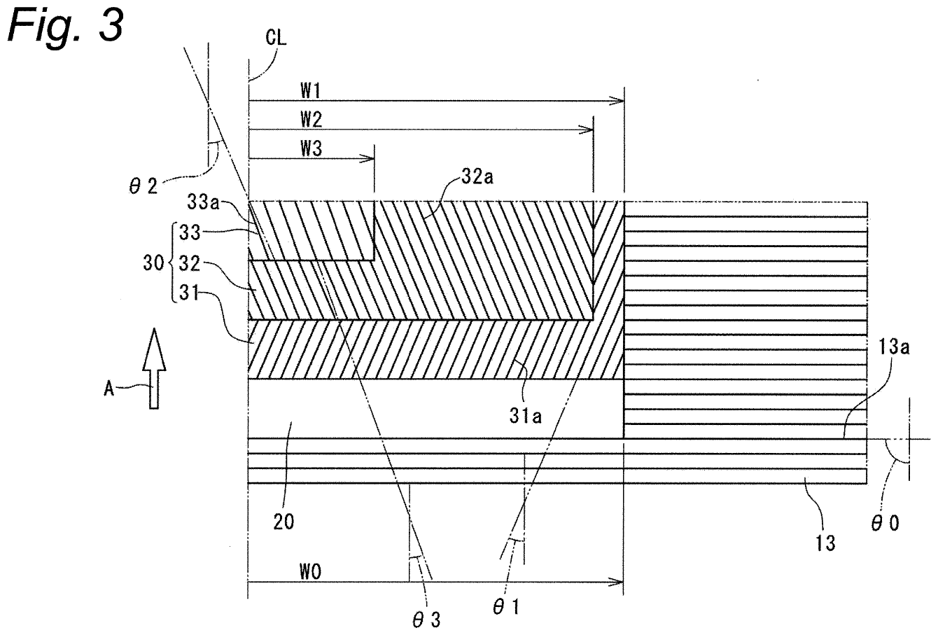

The carcass ply 13 has a plurality of carcass cords 13a (shown in FIG. 3) disposed parallel to each other and a topping rubber covering the plurality of carcass cords 13a. The plurality of carcass cords 13a of the present embodiment are made of steel.

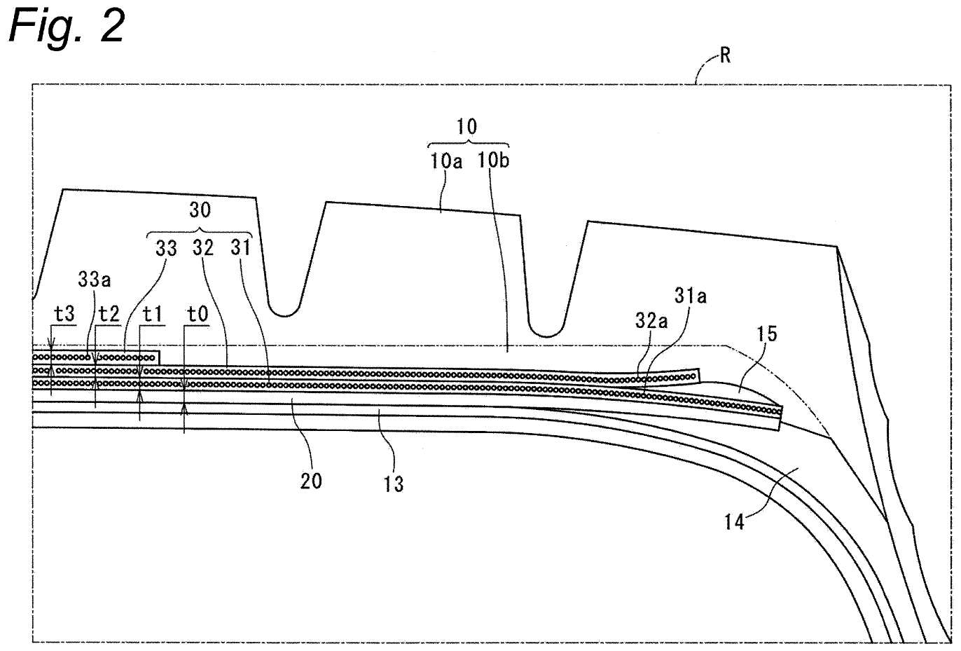

FIG. 2 is an enlarged view of a region R in FIG. 1.

Referring to FIG. 2, the tread 10 includes a cap rubber 10a constituting the outer surface of the tread 10, and a base rubber 10b stacked on the radially inner side of the cap rubber 10a. The 100% modulus of the base rubber 10b is 1 MPa or more and 4 MPa or less. The 100% modulus of the cap rubber 10a is 50% or more and 200% or less when the 100% modulus of the base rubber 10b is 100%. The 100% modulus of each member is a value obtained by dividing a tensile force when a test piece defined in JIS K6251:2010 3.7 is elongated by 100% by an initial cross-sectional area of the test piece (using dumbbell-shaped No. 3).

The main function of the rubber layer 20 is to improve the impact resistance of the pneumatic tire 1. The rubber layer 20 also functions as a buffer layer that suppresses transmission of deformation of the carcass ply 13 to the belt layer 30 and the tread 10 when a load is applied to the pneumatic tire 1. The rubber layer 20 is disposed adjacent to the radially outer side with respect to the carcass ply 13.

The belt layer 30 of the present embodiment composes of a first belt 31, a second belt 32, and a third belt 33.

The main function of the first belt 31 is to apply a radial restraining force to the carcass ply 13. The first belt 31 is disposed adjacent to the radially outer side with respect to the rubber layer 20. In other words, the first belt 31 is stacked on the radially outer side of the rubber layer 20. The first belt 31 is a belt located on the radially innermost side among the three layers of belts 31, 32, and 33 composing of the belt layer 30.

The first belt 31 includes a plurality of cords 31a disposed in parallel to each other and a topping rubber covering the plurality of cords 31a. The plurality of cords 31a of the first belt 31 of the present embodiment are made of steel.

An axial end of the first belt 31 is disposed at substantially the same position in the tire axial direction as an axial end of the rubber layer 20. In other words, the axial end of the first belt 31 is aligned with the axial end of the rubber layer 20 in the tire axial direction.

The main function of the second belt 32 is to apply a radial restraining force to the carcass ply 13. The second belt 32 is disposed adjacent to the first belt 31 on the radially outer side. In other words, the second belt 32 is stacked on the radially outer side of the first belt 31. The second belt 32 is a belt located at the radial center among the three layers of belts 31, 32, and 33 composing of the belt layer 30.

The second belt 32 includes a plurality of cords 32a disposed in parallel to each other and a topping rubber covering the plurality of cords 32a. The plurality of cords 32a of the second belt 32 of the present embodiment are made of steel.

The main function of the third belt 33 is to protect the first belt 31 and the second belt 32 to improve external damage resistance of the pneumatic tire 1. The third belt 33 is disposed adjacent to the second belt 32 on the radially outer side. In other words, the third belt 33 is stacked on the radially outer side of the second belt 32. The third belt 33 is a belt located on the radially outermost side among the three layers of belts 31, 32, and 33 composing of the belt layer 30. The third belt 33 is disposed adjacent to the base rubber 10b on the radially inner side. In other words, the third belt 33 is stacked on the radially inner side of the base rubber 10b.

The third belt 33 includes a plurality of cords 33a disposed in parallel to each other and a topping rubber covering the plurality of cords 33a. The plurality of cords 33a of the third belt 33 of the present embodiment are made of steel.

The end count of the first belt 31 of the present embodiment, that is, the number of driven cords 31a per 1 inch is 12/inch. The end count of the first belt 31 is preferably 6.5/inch or more and 23.5/inch or less.

The end count of the second belt 32 of the present embodiment is 12/inch. The end count of the second belt 32 is preferably 6.5/inch or more and 23.5/inch or less. The end count of the third belt 33 of the present embodiment is 9/inch. That is, the end count of the third belt 33 of the present embodiment is smaller than the end count of the first belt 31 and the end count of the second belt 32. The end count of the third belt 33 is preferably 70% or more and 80% or less of the end count of the first belt 31 or the end count of the second belt 32.

The 100% modulus of the rubber layer 20 of the present embodiment is 3.7 MPa or more and 4.6 MPa or less.

The 100% modulus of the topping rubber of the first belt 31 of the present embodiment is 3.7 MPa or more and 4.6 MPa or less. The 100% modulus of the topping rubber of the first belt 31 is the same as the 100% modulus of the rubber layer 20. In other words, the composition of the topping rubber of the first belt 31 is the same as the composition of the rubber constituting the rubber layer 20.

The 100% modulus of the topping rubber of the second belt 32 of the present embodiment is 3.7 MPa or more and 4.6 MPa or less. The 100% modulus of the topping rubber of the second belt 32 is the same as the 100% modulus of the rubber layer 20 and the 100% modulus of the topping rubber of the first belt 31. In other words, the composition of the topping rubber of the second belt 32 is the same as the composition of the rubber constituting the rubber layer 20 and the composition of the topping rubber of the first belt 31.

The 100% modulus of the topping rubber of the third belt 33 of the present embodiment is 3.7 MPa or more and 4.6 MPa or less. The 100% modulus of the topping rubber of the third belt 33 is the same as the 100% modulus of the rubber layer 20, the 100% modulus of the topping rubber of the first belt 31, and the 100% modulus of the topping rubber of the second belt 32. In other words, the composition of the topping rubber of the third belt 33 is the same as the composition of the rubber constituting the rubber layer 20, the composition of the topping rubber of the first belt 31, and the composition of the topping rubber of the second belt 32.

A thickness t0 of the rubber layer 20 of the present embodiment, that is, the dimension in the tire radial direction is 1.7 mm. The thickness t0 of the rubber layer 20 is preferably 1.5 mm or more and 2.5 mm or less.

A thickness t1 of the first belt 31 of the present embodiment is 1.7 mm. The thickness t1 of the first belt 31 is preferably within a range of ±15% around 1.7 mm.

A thickness t2 of the second belt 32 of the present embodiment is 1.7 mm. That is, the thickness t2 of the second belt 32 of the present embodiment is the same as the thickness t0 of the rubber layer 20 and the thickness t1 of the first belt 31. The thickness t2 of the second belt 32 is preferably within a range of ±15% around 1.7 mm.

A thickness t3 of the third belt 33 of the present embodiment is 1.9 mm. That is, the thickness t3 of the third belt 33 of the present embodiment is larger than the thickness t0 of the rubber layer 20, the thickness t1 of the first belt 31, and the thickness t2 of the second belt 32. The thickness t3 of the third belt 33 is preferably within a range of ±15% around 1.7 mm.

The numerical values (including upper and lower limit values of the numerical range) of the thicknesses t0 to t3 do not need to be geometrically strict values as long as they allow substantially unavoidable errors and satisfy the functions required for the rubber layer 20 and the belts 31, 32, and 33.

The pneumatic tire 1 includes a cushion rubber 14 and a pad rubber 15.

The cushion rubber 14 is disposed between the carcass ply 13 and the rubber layer 20. The 100% modulus of the cushion rubber 14 is 2.0 MPa or more and 3.5 MPa. The 100% modulus of the cushion rubber 14 is different from the 100% modulus of the rubber layer 20 and the 100% modulus of the topping rubber of the first belt 31.

The pad rubber 15 is disposed at an axial end of the first belt 31. The pad rubber 15 is disposed between the first belt 31 and the second belt 32. The 100% modulus of the pad rubber 15 is 3.7 MPa or more and 4.6 MPa or less. In the present embodiment, the 100% modulus of the pad rubber 15 is different from the 100% modulus of the rubber layer 20 and the 100% modulus of the topping rubber of the first belt 31.

FIG. 3 is a developed view of the carcass ply 13, the rubber layer 20, and the belt layer 30 of the pneumatic tire 1 according to the present embodiment. Referring to FIG. 3, each carcass cord 13a of the carcass ply 13 is disposed so as to extend in the tire axial direction. In other words, an angle θ0 of each carcass cord 13a with respect to the tire circumferential direction is set to 90 degrees.

Hereinafter, inclination angles (cord angles) θ1, θ2, and θ3 of the cords 31a, 32a, and 33a of the three layers of belts 31, 32, and 33 composing of the belt layer 30 with respect to the tire circumferential direction will be described. In the following description, with respect to the cord angles θ1 to θ3, a case where the cords 31a, 32a, and 33a extend away from the tire equator line CL toward the right side in FIG. 3 with reference to the direction indicated by the arrow A in FIG. 3 may be referred to as positive slope. Further, with respect to the cord angles θ1 to θ3, a case where the cords 31a, 32a, and 33a extend away from the tire equator line CL toward the left side in FIG. 3 with reference to the direction indicated by the arrow A in FIG. 3 may be referred to as negative slope.

The cord angle θ1 of the cord 31a of the first belt 31 is 23 degrees (positive slope) in the present embodiment. The cord angle θ1 may be set within a range of 23±5 degrees, and is preferably set within a range of 23±1 degree. In other words, the cord angle θ1 is preferably 22 degrees or more and 24 degrees or less.

The cord angle θ2 of the cord 32a of the second belt 32 is 23 degrees (negative slope) in the present embodiment. The cord angle θ2 may be set within a range of 23±5 degrees, and is preferably set within a range of 23±1 degree. In other words, the cord angle θ2 is preferably 22 degrees or more and 24 degrees or less.

The cord angles θ1 and θ2 of the first belt 31 and the second belt 32 are set such that the cords 31a and 32a extend in different directions with respect to the tire equator line CL. That is, one of the cord angles θ1 and θ2 is set to positive slope and the other is set to negative slope.

The cord angle θ3 of the cord 33a of the third belt 33 is 20 degrees (negative slope) in the present embodiment. The cord angle θ3 may be set within a range of 20±5 degrees, and is preferably set within a range of 20±1 degree. In other words, the cord angle θ3 is preferably 19 degrees or more and 21 degrees or less.

The numerical values (including upper and lower limit values of the numerical range) of the cord angles θ1 to θ3 do not need to be geometrically strict values as long as they allow substantially unavoidable errors and satisfy the functions required for the belts 31, 32, and 33. The same applies to the angle θ0 of the carcass cord 13a with respect to the tire circumferential direction.

A width W0 of the rubber layer 20 of the present embodiment, that is, the dimension in the tire axial direction is 214 mm. A width W1 of the first belt 31 of the present embodiment is 214 mm. A width W2 of the second belt 32 of the present embodiment is 194 mm. A width W3 of the third belt 33 of the present embodiment is 79 mm.

The width W0 of the rubber layer 20 is preferably 107 mm or more and 214 mm or less. The width W0 of the rubber layer 20 is 50% or more and 100% or less of the width W1 of the first belt 31.

The numerical values (including upper and lower limit values of the numerical range) of the widths W0 to W3 do not need to be geometrically strict values as long as they allow substantially unavoidable errors and satisfy the functions required for the rubber layer 20 and the belts 31, 32, and 33.

### Effects

The pneumatic tire 1 according to the present embodiment has the following effects.

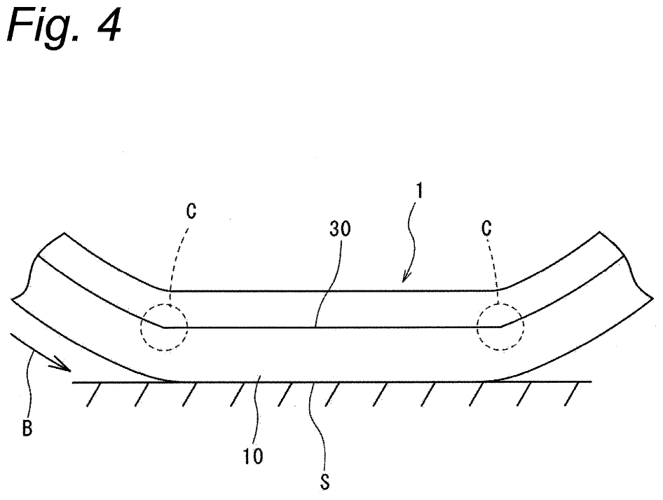

According to the present embodiment, it is possible to improve the uniformity of the circumferential distribution of the ground contact pressure on the tire ground contact surface. As conceptually shown in FIG. 4, in the loaded state (state of being mounted on the vehicle), the cords 31a, 32a, and 33a of the three layers of belts 31, 32, and 33 composing of the belt layer 30 are bent in the front and rear regions (symbol C) in the tire rotation direction shown by the arrow B with respect to the tire ground contact surface S of the tread 10. As the radial binding force by the belt layer 30 is smaller, the belt layer 30 is more likely to be deformed following the road surface due to the bending generated in the cords 31a, 32a, and 33a, and as a result, the tread 10 is more likely to be deformed following the road surface. According to the present embodiment, since the pneumatic tire 1 includes the belt layer 30 composing of the three layers of belts 31, 32, and 33, it is possible to suppress an excessive increase in the radial restraining force by the belt layer 30 as compared with the case where the belt layer of the pneumatic tire includes four or more layers of belts. As a result, the tread 10 of the pneumatic tire 1 is easily deformed following the road surface, and the uniformity of circumferential distribution of the ground contact pressure on the tire ground contact surface can be improved.

According to the present embodiment, since the rubber layer 20 disposed between the first belt 31 and the carcass ply 13 functions as a buffer layer that absorbs the deformation of the carcass ply 13, it is possible to suppress the deformation of the carcass ply 13 from being transmitted to the belt layer 30 and the tread 10.

According to the present embodiment, since the modulus of the rubber layer 20 is the same as the modulus of the topping rubber of the first belt 31, the rubber layer 20 and the topping rubber of the first belt 31 exhibit substantially the same behavior when a load is applied to the pneumatic tire 1. As a result, it is possible to suppress the occurrence of separation between the rubber layer 20 and the first belt 31.

According to the present embodiment, since the thickness t0 of the rubber layer 20 is 1.5 mm or more and 2.0 mm or less, sufficient impact resistance of the pneumatic tire 1 can be secured, and at the same time, it is possible to suppress the rubber layer 20 from becoming excessively thick.

The cord angles θ1 and θ2 of the first and second belts 31 and 32 of the present embodiment are 22 degrees or more and 24 degrees or less. Therefore, according to the present embodiment, as compared with the case where the cord angles θ1 and θ2 are 0 degrees or more and 21 degrees or less, the radial binding force by the belt layer 30 is weakened. As a result, the tread 10 of the pneumatic tire 1 is easily deformed following the road surface, and the uniformity of circumferential distribution of the ground contact pressure on the tire ground contact surface can be improved. On the other hand, the cord angle θ3 of the third belt 33 of the present embodiment is smaller than the cord angles θ1 and θ2 of the first and second belts 31 and 32, and is 19 degrees or more and 21 degrees or less. Therefore, according to the present embodiment, as compared with the case where the cord angle θ3 of the third belt 33 is equal to the cord angles θ1 and θ2 of the first and second belts 31 and 32, it is possible to suppress the radial restraint force by the belt layer 30 from being excessively weakened. As described above, it is possible to improve the uniformity of circumferential distribution of the ground contact pressure on the tire ground contact surface while securing the radial restraint force by the belt layer 30.

The thickness t3 of the third belt 33 of the present embodiment is larger than the thickness t1 of the first belt 31 and the thickness t2 of the second belt 32. According to the present embodiment, external damage resistance of the pneumatic tire 1 can be improved as compared with a case where the thickness t3 of the third belt 33 is thinner than the thickness t1 of the first belt 31 or the thickness t2 of the second belt 32.

The end count of the third belt 33 of the present embodiment is smaller than the end count of the first belt 31 and the end count of the second belt 32. For example, in the present embodiment, the end count of the third belt 33 is 70% or more and 80% or less of the end count of the first belt 31 and the end count of the second belt 32. According to the present embodiment, the weight of the pneumatic tire 1 can be reduced as compared with a case where the end count of the third belt 33 is larger than the end count of the first belt 31 or the end count of the second belt 32.

The thickness t1 of the first belt 31 and the thickness t2 of the second belt 32 of the present embodiment are the same as the thickness to of the rubber layer 20. According to the present embodiment, as compared with the case where the thickness t1 of the first belt 31 and the thickness t2 of the second belt 32 are thinner than the thickness t0 of the rubber layer 20, it is possible to suppress the deformation of the carcass ply 13 from being transmitted to the tread 10. Here, “the thickness t1 of the first belt 31 or the thickness t2 of the second belt 32 is the same as the thickness t0 of the rubber layer 20” does not need to be the same in a geometrically strict sense as long as an unavoidable error is allowed and the above-described effect is exhibited. For example, “the thickness t1 of the first belt 31 or the thickness t2 of the second belt 32 is the same as the thickness t0 of the rubber layer 20” includes a case where the thickness t1 of the first belt 31 or the thickness t2 of the second belt 32 is 90% or more and 110% or less of the thickness t0 of the rubber layer 20.

The width W0 of the rubber layer 20 in the tire axial direction of the present embodiment is 50% or more and 100% or less of the width W1 of the first belt 31 in the tire axial direction. According to the present embodiment, since distortion at the axial end of the first belt 31 is suppressed, it is possible to suppress the occurrence of separation between the rubber layer 20 and the first belt 31.

The pneumatic tire according to the present disclosure is not limited to the configuration of the above embodiment, and various modifications can be made.

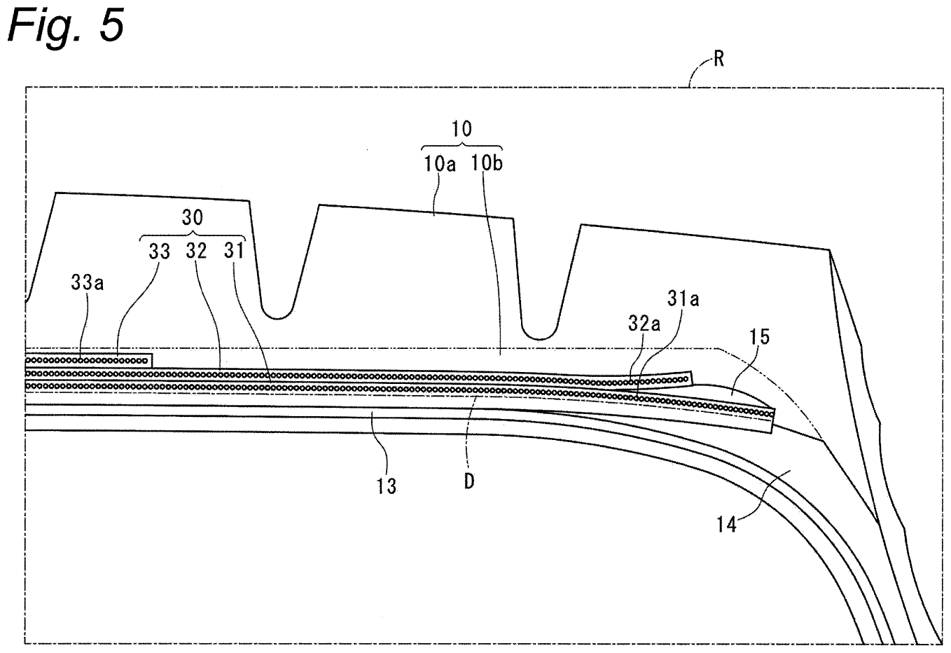

FIG. 5 shows a pneumatic tire 1 according to a modification of the present embodiment. The pneumatic tire 1 of the present modification has the same configuration as that of the above embodiment except that the rubber layer 20 and the first belt 31 are integrally formed, and the rubber layer 20 and the first belt 31 cannot be clearly distinguished. The pneumatic tire 1 according to the present modification does not include the rubber layer 20, and the cord 31a of the first belt 31 according to the present modification is disposed on the outer side in the tire radial direction with respect to the radial center D of the first belt 31. In other words, the cord 31a of the first belt 31 is disposed biased outward in the tire radial direction in the first belt 31. The pneumatic tire 1 according to the present modification has the same effects as those of the above embodiment.

### Supplementary Note

A pneumatic tire for heavy loads according to the present disclosure provides the following aspects.

### First Aspect

The present disclosure provides a pneumatic tire for heavy loads, including: a belt layer composed of three layers of belts; and a rubber layer, the belt layer and the rubber layer being disposed between a carcass ply and a tread, each belt having a plurality of cords and a topping rubber covering the plurality of cords,
in which the belt layer includes:
   a first belt disposed on an outer side of the rubber layer in a tire radial direction;
   a second belt disposed on an outer side of the first belt in the tire radial direction; and
   a third belt disposed on an outer side of the second belt in the tire radial direction,
in which a modulus of the rubber layer is the same as a modulus of the topping rubber of the first belt, and
in which the rubber layer has a thickness of 1.5 mm or more and 2.0 mm or less.

### Second Aspect

The present disclosure provides the pneumatic tire for heavy loads according to the first aspect,
in which a cord angle of the first belt and a cord angle of the second belt are 22 degrees or more and 24 degrees or less, and
in which a cord angle of the third belt is 19 degrees or more and 21 degrees or less.

### Third Aspect

The present disclosure provides the pneumatic tire for heavy loads according to the first or second aspect,
in which a thickness of the third belt is larger than a thickness of the first belt or a thickness of the second belt.

### Fourth Aspect

The present disclosure provides the pneumatic tire for heavy loads according to any one of the first to third aspects,
in which an end count of the third belt is smaller than an end count of the first belt or an end count of the second belt.

### Fifth Aspect

The present disclosure provides the pneumatic tire for heavy loads according to the fourth aspect,
in which the end count of the third belt is 70% or more and 80% or less of the end count of the first belt or the end count of the second belt.

### Sixth Aspect

The present disclosure provides the pneumatic tire for heavy loads according to any one of the first to fifth aspects,
in which a thickness of the first belt or a thickness of the second belt is the same as the thickness of the rubber layer.

### Seventh Aspect

The present disclosure provides the pneumatic tire for heavy loads according to any one of the first to sixth aspects,
in which a width of the rubber layer in a tire axial direction is 50% or more and 100% or less of a width of the first belt in the tire axial direction.

### Eighth Aspect

The present disclosure provides a pneumatic tire for heavy loads, including a belt layer composed of three layers of belts disposed between a carcass ply and a tread, each belt having a plurality of cords and a topping rubber covering the plurality of cords,
in which the belt layer includes:
   a first belt disposed on an outer side of the carcass ply in a tire radial direction;
   a second belt disposed on an outer side of the first belt in the tire radial direction; and
   a third belt disposed on an outer side of the second belt in the tire radial direction,
in which the plurality of cords of the first belt are disposed outside, in the tire radial direction, a radial center of the first belt.

What is claimed is:

1. A pneumatic tire for heavy loads, comprising: a belt layer composed of three layers of belts; and a rubber layer, the belt layer and the rubber layer being disposed between a carcass ply and a tread, each belt having a plurality of cords and a topping rubber covering the plurality of cords,
wherein the belt layer includes:
a first belt disposed on an outer side of the rubber layer in a tire radial direction;
a second belt disposed on an outer side of the first belt in the tire radial direction; and
a third belt disposed on an outer side of the second belt in the tire radial direction,
wherein a modulus of the rubber layer is the same as a modulus of the topping rubber of the first belt, and
wherein the rubber layer has a thickness of 1.5 mm or more and 2.0 mm or less.

2. The pneumatic tire for heavy loads according to claim 1, wherein
a cord angle of the first belt and a cord angle of the second belt are 22 degrees or more and 24 degrees or less, and
wherein a cord angle of the third belt is 19 degrees or more and 21 degrees or less.

3. The pneumatic tire for heavy loads according to claim 1, wherein a thickness of the third belt is larger than a thickness of the first belt or a thickness of the second belt.

4. The pneumatic tire for heavy loads according to claim 2, wherein a thickness of the third belt is larger than a thickness of the first belt or a thickness of the second belt.

5. The pneumatic tire for heavy loads according to claim 1, wherein an end count of the third belt is smaller than an end count of the first belt or an end count of the second belt.

6. The pneumatic tire for heavy loads according to claim 2, wherein an end count of the third belt is smaller than an end count of the first belt or an end count of the second belt.

7. The pneumatic tire for heavy loads according to claim 3, wherein an end count of the third belt is smaller than an end count of the first belt or an end count ends of the second belt.

8. The pneumatic tire for heavy loads according to claim 5, wherein the end count of the third belt is 70% or more and 80% or less of the end count of the first belt or the end count of the second belt.

9. The pneumatic tire for heavy loads according to claim 1, wherein a thickness of the first belt or a thickness of the second belt is the same as the thickness of the rubber layer.

10. The pneumatic tire for heavy loads according to claim 2, wherein a thickness of the first belt or a thickness of the second belt is the same as the thickness of the rubber layer.

11. The pneumatic tire for heavy loads according to claim 3, wherein the thickness of the first belt or the thickness of the second belt is the same as the thickness of the rubber layer.

12. The pneumatic tire for heavy loads according to claim 5, wherein a thickness of the first belt or a thickness of the second belt is the same as the thickness of the rubber layer.

13. The pneumatic tire for heavy loads according to claim 8, wherein a thickness of the first belt or a thickness of the second belt is the same as the thickness of the rubber layer.

14. The pneumatic tire for heavy loads according to claim 1, wherein a width of the rubber layer in a tire axial direction is 50% or more and 100% or less of a width of the first belt in the tire axial direction.

15. The pneumatic tire for heavy loads according to claim 2, wherein a width of the rubber layer in a tire axial direction is 50% or more and 100% or less of a width of the first belt in the tire axial direction.

16. The pneumatic tire for heavy loads according to claim 3, wherein a width of the rubber layer in a tire axial direction is 50% or more and 100% or less of a width of the first belt in the tire axial direction.

17. The pneumatic tire for heavy loads according to claim 5, wherein a width of the rubber layer in a tire axial direction is 50% or more and 100% or less of a width of the first belt in the tire axial direction.

18. The pneumatic tire for heavy loads according to claim 8, wherein a width of the rubber layer in a tire axial direction is 50% or more and 100% or less of a width of the first belt in the tire axial direction.

19. The pneumatic tire for heavy loads according to claim 9, wherein a width of the rubber layer in a tire axial direction is 50% or more and 100% or less of a width of the first belt in the tire axial direction.

20. A pneumatic tire for heavy loads, comprising a belt layer composed of three layers of belts disposed between a carcass ply and a tread, each belt having a plurality of cords and a topping rubber covering the plurality of cords,
wherein the belt layer includes:
a first belt disposed on an outer side of the carcass ply in a tire radial direction;
a second belt disposed on an outer side of the first belt in the tire radial direction; and
a third belt disposed on an outer side of the second belt in the tire radial direction,
wherein the plurality of cords of the first belt are disposed outside, in the tire radial direction, a radial center of the first belt.
